(19) United States
(12) Patent Application Publication
(10) Pub. No.: US 2008/0127996 A1
(43) Pub. Date: Jun. 5, 2008

(54) METHOD AND APPARATUS TO REMEDIATE AN ACID AND/OR LIQUID SPILL

(76) Inventor: Dennis G. Weinhold, Phoenix, AZ (US)

Correspondence Address: WOOD, HERRON & EVANS, LLP, 2700 CAREW TOWER, 441 VINE STREET, CINCINNATI, OH, 45202, US

(21) Appl. No.: 11/947,984

(22) Filed: Nov. 30, 2007

Related U.S. Application Data
(60) Provisional application No. 60/868,495, filed on Dec. 4, 2006.

(51) Int. Cl. B08B 7/00

(52) U.S. Cl. 134/7; 134/198

(57) ABSTRACT

Liquid spills are remediated by spraying essentially dry polymeric liquid-sorbing solid particles with a pressurized propellant gas from a reservoir onto the liquid spill for disposal or reclamation. The liquid spill, such as sulfuric or hydrochloric acid, is sorbed into the solid gel particles, thereby enabling collection of the gel particles containing the absorbed liquid.

### RELATED APPLICATION

This application is a nonprovisional application based upon a provisional application entitled “Apparatus, Composition, and Method to Remediate an Acid and/or Liquid Spill”, Serial No. 06/868,495, filed Dec. 4, 2006, which is incorporated herein in its entirety by reference.

### FIELD OF THE INVENTION

This invention is directed to a method for remediating the release of liquids, including acids such as sulfuric acid and hydrochloric acid. An apparatus is provided by this invention for effectively cleaning up spills of hazardous liquids by converting them to solids for facilitating the removal of the resulting solids from the environment.

### BACKGROUND OF THIS INVENTION

Methods are known for producing gels containing sulfuric acid. In particular, absorbent polymers prepared by polymerizing acrylic acid, methacrylic acid, or amides thereof, with crosslinking agents, result in a gel, and when the gel is dried and ground into particles, the resultant gel particles absorb sulfuric acid. U.S. Pat. No. 3,765,950, is directed to such a process of preparing a gel containing concentrated sulfuric acid for use in lead accumulators, having dry storable charged electroplates. The dried resin particles have sizes on the order of about 1-5 mm which absorb the sulfuric acid. U.S. Pat. No. 2,596,046 is also directed to a method of reducing or avoiding hazards in the storage, shipment, and use of sulfuric acid, which may result by liquid flow from broken containers, causing injury to persons handling it. The objective of the '046 patent was to reduce or avoid the hazards by providing solid or gelatinous compositions which are rich in sulfuric acid by adding sulfonic acids of alkenyl aromatic resins as thickening agents for sulfuric acid. The resulting compositions have been suggested for use in fire extinguishers, where the liquid sulfuric acid is gradually leached from the composition for reaction with an aqueous metal carbonate to generate carbon dioxide and foam that is usually obtained with such extinguishers. U.S. Pat. Nos. 2,684,590 and 3,419,430 also disclose sulfuric acid gels that result by thickening sulfuric acid with polymers.

In view of the current state of the art, as exemplified by the above patents, improvements are needed in dealing with the release of hazardous liquids caused by spilling, leaking, leaching, dumping, etc., into the environment. Improvements are needed in converting hazardous liquids, such as acids, into solids for their convenient and safe removal from the environment.

### SUMMARY OF THE INVENTION

This invention is directed to the remediation of a liquid release, particularly acids like sulfuric acid and hydrochloric acid. Many liquids of a hazardous nature can be conveniently and safely cleaned up from the environment.

In summary, the inventive method of remediating a liquid comprises providing a reservoir containing essentially dry polymeric liquid-sorbing solid particles and a pressurized propellant gas, spraying the solid polymeric particles from the reservoir onto the released liquid to sorb the liquid in the solid particles, and collecting the resulting solid particles, containing the sorbed liquid.

The terms “liquid-sorbing”, “adsorb(s,ed)”, “absorb(s,ed)” or “sorb(s,ed)” as used herein, or variations thereof, are used to describe the property or activity of the polymeric particles which converts the released liquid into a manageable solid for remediation. Thus, the method converts a liquid spill into a manageable solid which can be readily handled for disposal or reclamation of the acid and even the solid gel particles. The disposal may be by neutralization of the acid and incorporation in a landfill. The particles containing the acid may be used as an acid source, for example. The terms “disposal(e, ed)”, with respect to the resultant particles containing the sorbed liquid, mean they can be adapted, handled, etc., in any one of a number of ways in ultimately dealing with the remediation.

The apparatus employed in the method comprises a reservoir containing the dry solid polymeric liquid-sorbing particles, and a source of pressurized propellant gas in communication with the reservoir, an actuator mechanism interconnected with the source of pressurized propellant gas, and a discharge nozzle in communication with the reservoir for spraying the particles onto the liquid spill for absorption and disposal or reclamation of the liquid.

It has been found that the particle sizes of the dry polymeric solid particles are important in the practice of the best mode of this invention. For example, while smaller particle sizes provide more surface area for the liquid being, they have a tendency to clump together, which sometimes renders the internal portions of the clumps nonsorbing. Furthermore, the smaller particles also exhibit dusting when handled or sprayed, and dusting may become a problem, thereby requiring specialized equipment to be employed during spraying. In contrast, the larger particle sizes have less surface area, and do not absorb or adsorb as quickly. Moreover, larger particle sizes have a tendency to release the initially absorbed liquid over a period of time. Accordingly, utilizing the best mode of practice for the method and apparatus of this invention, it has been found that average particle sizes on the order of about 0.1-0.5 mm are preferred. These particle sizes are considered to be the best, according to the present mode of this invention, because they will absorb liquids without clumping, and the resulting solids inhibit the release of the absorbed liquid. Furthermore, particle sizes of this order of magnitude have been effectively dispersed in ordinary fire-extinguishing type apparatus without clogging, and may be sprayed without causing a dusting problem that is associated with smaller-size particles. Blends of the polymeric particles are also employed to provide a range of particle sizes which result in disposable solids which contain sorbed liquid, which may be more readily disposed of in the environment.

In a preferred mode, the dry polymeric liquid-sorbing particles are cross-linked polymeric gels which form a matrix for the absorption and/or adsorption of the liquid to be remediated. Thus, a cross-linked polymer or copolymer of monomers selected from the group consisting of acrylic acid, methacrylic acid, ethylacrylic acid, butylacrylic acid, 2-ethylhexylacrylic acid, an amide or alkali metal salt of said acid, are suitable for use.

### BRIEF DESCRIPTION OF THE DRAWINGS

FIG. 1 illustrates a typical apparatus in the form of a fire-extinguishing apparatus which may be hand-carried to the site of an acid release/liquid release.

FIG. 2 illustrates an apparatus which comprises a wheeled cart for the delivery of the inventive device to the site of an acid release/liquid release for remediation.

### DETAILED DESCRIPTION

The following examples further illustrate the practice of the method and apparatus of this invention. However, these examples are not intended to limit the scope of the invention.

Examples 1-11 demonstrate the effectiveness of the cross-linked polymers and copolymers with respect to their absorption efficiency and retention of acidic liquids, like hydrochloric acid, sulfuric acid and hydrofluoric acid into disposable solids.

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment”, “in an embodiment”, and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In one embodiment, the invention utilizes an acid spill remediation formulation comprising one or more cross-linked acrylamide polymers. For example and without limitation, an acid spill remediation formulation comprises a cross-linked polyacrylamide powder formed from the copolymerization of acrylamide and N,N′-methylene bisacrylamide. In certain embodiments, the mole ratio of acrylamide to bisacrylamide is between about 1:10 to about 1:1000.

It has been found that cross-linked polyacrylamide polymers formed from acrylamide and bisacrylamide, for example, are suitable for use in the method and apparatus of this invention.

Spraying a dry powder of such a cross-linked polymer gel from a pressurized gas container effectively delivers the powder to capture a liquid spill and convert it into a solid material that can be easily handled using, for example and without limitation, a shovel, a broom, and the like. The following examples 1-12 further illustrate to persons skilled in the art how to make and use the invention.

### EXAMPLE 1

About 8 grams of a cross-linked polyacrylamide material, sold in commerce under the trade name Petroleum Environmental Technologies, Inc. “Enviro-Bond 300”, was distributed onto about 20 grams of 96.2% sulfuric acid at (63° F.) room temperature. The temperature rose to a maximum of about 140° F. After about 55 seconds, an intact gel was formed, wherein that gel could be manipulated intact, and could be handled using a spatula, spoon, tongs, and the like.

### EXAMPLE 2

About 20 grams of cross-linked polyacrylamide powder, sold in commerce under the trade name Petroleum Environmental Technologies, Inc. “PET 300CO”, having average particle sizes of about 1.7-4.0 mm, were distributed onto about 80 grams of hydrochloric acid (14.5%). The powder was swirled by hand in a closed container and showed swelling of the absorbent powder in about 20-60 minutes. At about 93 minutes, the powder was still swelling, and swirling by hand was continued until almost all of the acid was absorbed in about 120 minutes. After absorption of the liquid HCl, it was noted that, after four hours, liquid HCl was being released. It was noted that more liquid HCl was released upon inspection of the container two days later, and the product was now considered to be a rubber-like gel. About two weeks later, the product had the appearance of a hardened solid mass, but most of the HCl appeared to have been released. Upon final inspection three days later, the same observations were made. This Example 2 illustrates that average particle sizes of about 1.7 to 4 mm have limited capability is sorbing HCl and will release the acid after a period of time.

### EXAMPLE 3

About 10 grams of a cross-linked copolymer of acrylamide and potassium acrylate, sold in commerce under the trade name “SNF Floerger”, AQUASORB 3005 KC, having a particle size of about 0.1 to 0.5 mm, was distributed onto about 80 grams of hydrochloric acid, and a gel was formed in two (2) minutes upon swirling by hand in a closed container. The product remained in a solid gel state and no sign of HCl release was noted upon inspection of the sample two days later. The same observation was made nearly two weeks later, and after about twenty days, the solid gel remained like a rubber, and only some small droplets were noted on the inside of the closed container. Accordingly, this cross-linked copolymer of acrylamide and potassium acrylate, having a particle size of about 0.1 to about 0.5 mm, was considered to be a preferred essentially dry powder for practice of the invention with appropriate apparatus as described hereinafter in Example 12.

### EXAMPLE 4

About 10 grams of a partial sodium salt of cross-linked polypropenoic acid (acrylic acid)>83% (CAS#9033-79-8) powder sold in commerce under the trade name Henwil Corporation's “HW 9140-60” was distributed in particle sizes described as: 40 mesh-15% max, minimum of 50% between 40-140 mesh with overall average particle size in the 40-60 mesh range, percent through 140 mesh is 35% max. and a maximum of 15% through 325 mesh on 80 grams of hydrochloric acid by swirling in a closed container. It was noted that the HCl did not absorb readily, and, it did not appear that any absorption was obtained in 20 minutes, 60 minutes, 93 minutes, 120 minutes, respectively. Furthermore, no change was observed upon daily inspections up to twenty days after the product was distributed onto the hydrochloric acid. It appeared that the product formed a clump in the center of the HCl liquid, wherefore it does not appear that this particular cross-linked powder would be satisfactory for absorbing hydrochloric acid. However, as reported hereinafter in later examples, the product was acceptable for absorption of sulfuric acid. When Henwil Corporation's smaller mesh-size product “HW 9164” with the same chemical makeup, with nearly all sub-100 mesh powder, the product was not effective in absorbing HCl. However, as reported later, it appeared to be more effective for absorption of sulfuric acid.

### EXAMPLE 5

A blend of 3 grams of Aquasorb KC and 10 grams of HW 9140-60 was deposited upon HCl in the same manner as Examples 2-4. The Aquasorb KC facilitated the sorption of HCl when mixed with the HW 9140-60 which, by itself (with reference to Example 4) does not effectively sorb HCl. The combination gelled in approximately one minute upon stirring the acid with a wooden stirring stick, which became a clump after sitting, and with further observation up to nearly twenty days after combining the particles with the acid, the sample swelled up and was still rubber-like. The blend of these products at different ratios still appeared to sorb the HCl in the same manner. In contrast, as reported in Examples 7-11, Aquasorb KC or HW 9140-60, each satisfactorily sorbed sulfuric acid when employed alone.

### EXAMPLE 6

A blend of 5 grams of Aquasorb KC and 5 grams of HW 9140-60 was mixed together and placed in a container with 80 grams of HCl poured on the particles. Again, the results were essentially the same as those reported for Example 5 above.

### EXAMPLES 7-11

The above Examples 2-6 were repeated, except employing 96.2% sulfuric acid as a substitute for the hydrochloric acid. Satisfactory absorptions of the sulfuric acid were noted with each of the powdered cross-linked polymers, that were employed in Examples 2-6. Absorptions at different rates for sulfuric acid than for hydrochloric acid were observed. However, the solid gels resulting with sulfuric acid were satisfactory as examples of remediation of sulfuric acid with the powdered polymeric cross-linked gels.

### EXAMPLE 12

In this example, the method and apparatus of the invention is illustrated. A RED LINE™ Model 10 hand-portable fire extinguisher, manufactured by Ansul, was employed as a suitable device for spraying the dry cross-linked polymeric powder of Aquasorb KC, reported in Example 3. The Model 10 fire extinguisher had a capacity of 10 pounds, with a discharge time of about 11 seconds for the discharge of dry powder at a flow rate of about 0.86 lbs./sec. with an effective range of about 21 feet, and an expanding nozzle stream. Further reference is made to Ansul Incorporated publication form No. F-9301-3 ©1999 for other details and this publication is incorporated herein by reference. The Model 10 fire extinguisher was fitted with a canister of propellant nitrogen gas (pressure 1800 psi), and charged with about 7-7½ pounds of the cross-linked copolymer of acrylamide and potassium acrylate of Example 3 above. A spray surface was set up by draping black plastic in a vertical fashion with a pool at the bottom of the vertical surface. One half-gallon of 96.2% sulfuric acid was placed in the pool at the bottom of the black plastic, and one quart of the sulfuric acid was sprayed onto the plastic surface. The level of the sulfuric acid in the pool was about 1 to 1.5 inches in height. This arrangement simulated a spill of sulfuric acid in order to evaluate the method and apparatus of this invention. The Ansul Model 10 hand extinguisher was then utilized to spray the cross-linked powder onto the vertical black plastic and into the bottom pool over a period of approximately 11 seconds. It was noticed that the powder adhered to the acid liquid on the vertical surface of the black plastic and in the liquid pool of acid. After about five minutes, it was noticed that the powder absorbed all of a sulfuric acid liquid, and no liquid was visible. Accordingly, the successful practice of the method by spraying the essentially dry powder of cross-linked gel was performed. The above Example 12 also satisfactorily demonstrates the apparatus as a delivery device to remediate a liquid release of the acidic type according to this invention.

In certain embodiments, this invention further comprises a more general liquid release remediation polymeric powder comprising a copolymer of acrylamide and acrylic acid. In other embodiments, a cross-linked ter-polymer is formed by cross-linking the copolymer with methylene bis-acrylamide.

Thus, it will be understood that the preferred dry cross-linked polymeric liquid-absorbing solid gel particles suitable for use can vary over a wide range of polymers which are exemplified by polymers and copolymers of acrylic acid, methacrylic acid, ethylacrylic acid, butylacrylic acid, 2-ethylhexylacrylic acid, their amides, alkali metal salts (Na/K) thereof, with various cross-linking agents such as methylene bis-acrylamide. Other liquid-sorbing solid particles can be employed, such as those known in the art including sulfonated alkenyl aromatic polymers. The term “liquid-sorbing” is also meant to include absorbing, adsorbing or reacting particles to provide solid or gelatinous masses which can be more readily handled. Examples of these cross-linked polymers and other gel-forming polymers are found in the description of the patents cited above in the background of this invention and such disclosures are incorporated herein by reference as will be understood to a person of skill in the art.

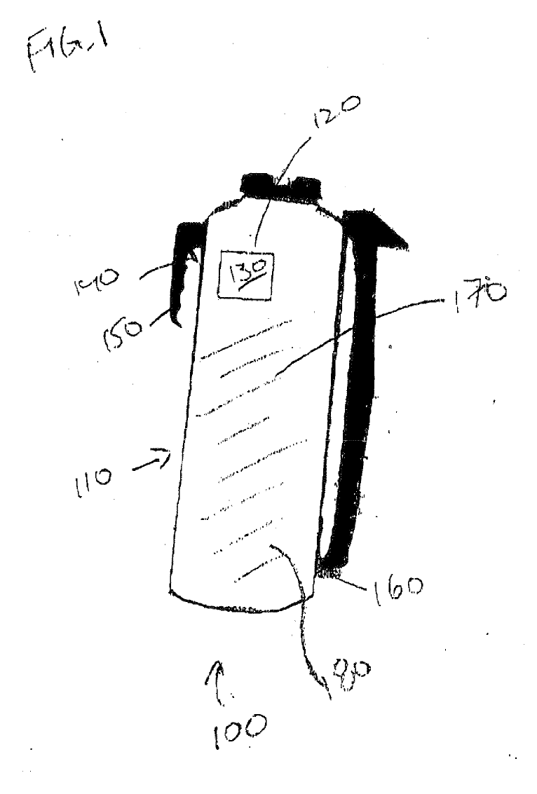

In certain apparatus embodiments, this invention further comprises a liquid-sorbing polymeric powder, disposed in a delivery device to remediate a liquid release comprising a reservoir containing the one or more polymeric materials, a source of one or more pressurized propellant gases in communication with the reservoir, an actuator mechanism interconnected with the source of pressurized propellant gas(es), and a discharge nozzle in communication with the reservoir. For example and referring now to FIG. 1, apparatus 100 comprises reservoir 110, an acid spill remediation powder 170 and/or liquid spill remediation powder 180 disposed within reservoir 110, container 120, one or more pressurized propellant gases 130, preferably nitrogen, releasably disposed within container 120, actuator 140, handle 150, and discharge nozzle 160.

Apparatus 100 can be hand-carried to the site of an acid release/liquid release. Discharge nozzle 160 is directed toward the released liquid material(s). Actuator 140 is actuated releasing the one or more pressurized propellant gases 130 from container 120. Propellant gases 130 cause powdered acid spill remediation formulation 170 and/or powdered liquid spill remediation formulation 180 to be dispensed outwardly from discharge nozzle 160 and onto the released acid/liquid.

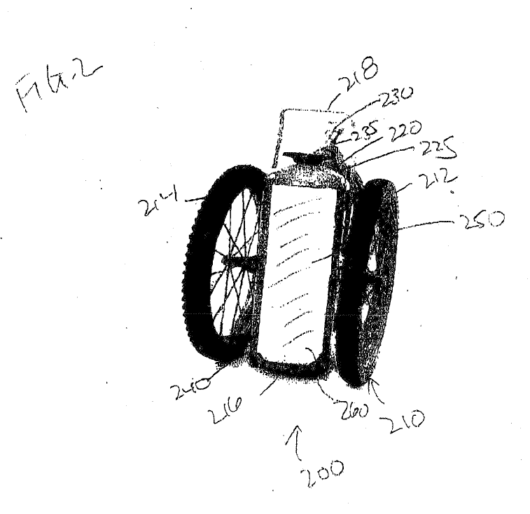

Referring to FIG. 2, apparatus 200 comprises a wheeled cart 210 comprising wheels 212 and 214, cart portion 216, handle 218, and reservoir 240. One or more pressurized propellant gases 225 are releasably disposed within the cylinder 220. Conduit 235 interconnects cylinder 220 and reservoir 240. Spill remediation powder 250 and/or liquid spill remediation powder 260 are disposed within reservoir 240.

Apparatus 200 can be moved to the site of an acid release/liquid release. Valve 230 is opened thereby releasing the one or more pressurized propellant gases 225 into reservoir 240 causing powdered acid spill remediation formulation 250 and/or powdered liquid spill remediation formulation 260 to be dispensed outwardly from a discharge nozzle in communication with reservoir 240 and onto the released acid/liquid.

While the preferred embodiments of the present invention have been illustrated in detail, it should be apparent that modifications and adaptations to those embodiments may occur to one skilled in the art without departing from the scope of the present invention.

What is claimed is:

1. A method of remediating a liquid release comprising
providing a reservoir containing essentially dry polymeric liquid-sorbing solid particles and a pressurized propellant gas, and
spraying the solid particles from the reservoir onto the released liquid to sorb the liquid in the solid particles,
collecting the resulting solid particles containing the sorbed liquid.

2. The method of claim 1, wherein the dry particles have an average particle size of about 0.1 to about 0.5 mm.

3. The method of claim 1, wherein the liquid release is an acid.

4. The method of claim 3, wherein the acid is selected from the group consisting of sulfuric acid and hydrochloric acid.

5. The method of claim 1, wherein the polymeric particles are cross-linked polymeric gel particles of a polymer or copolymer of monomers selecting from the group consisting of acrylic acid, methacrylic acid, ethylacrylic acid, butylacrylic acid, 2-ethylhexylacrylic acid, an amide or alkali metal salt of said acid, and blends thereof.

6. The method of claim 5, wherein said polymer is cross-linked with an unsaturated cross-linkable compound.

7. The method of claim 6, wherein the said unsaturated cross-linkable compound is methylene bisacrylamide.

8. The method of claim 1 wherein the solid particles are collected for disposal or reclamation.

9. An apparatus for remediating a liquid release comprising
a reservoir containing essentially dry polymeric liquid-sorbing solid particles and a source of pressurized propellant gas in communication with the reservoir,
an actuator mechanism interconnected with said source,
a discharge nozzle in communication with said reservoir for spraying said solid particles from said reservoir onto said liquid release to sorb said liquid in the solid particles.

10. The apparatus of claim 9, sized to be hand-carried for remediating the liquid release.

11. The apparatus of claim 9, further comprising a wheeled cart for holding the reservoir and transporting said reservoir to the site of remediating the liquid release.

12. The apparatus of claim 9 wherein said gas is nitrogen.
